(19) United States
(12) Patent Application Publication
(10) Pub. No.: US 2026/0103346 A1
(43) Pub. Date: Apr. 16, 2026

(54) MATERIAL PROCESSING SYSTEM, IN PARTICULAR A LASER PROCESSING SYSTEM, WITH A PALLET CHANGING SYSTEM

(71) Applicant: TRUMPF Werkzeugmaschinen SE + Co. KG, Ditzingen (DE)

(72) Inventors: Charles Macomber, Plainville, CT (US); James Silvestro, East Haddam, CT (US)

(21) Appl. No.: 18/915,394

(22) Filed: Oct. 15, 2024

(51) Int. Cl. B65G 35/06; B65G 47/91

(52) U.S. Cl. CPC B65G 35/06; B65G 47/91; B65G 2201/0267

(57) ABSTRACT

A material processing system with a pallet changing system includes a first base frame, a first pallet positionable on the first base frame, and a second base frame in alignment with the first base frame. The second base frame has two running rails on which the first pallet is displaceable longitudinally toward or away from the first base frame via rollers. A guide contour is arranged on one of the running rails for laterally guiding at least one roller, and/or at least one lateral guide element is fixed relative to the second base frame or the first pallet arranged in the second base frame and projects beyond one of the running rails so that, when a lateral force is applied onto the first pallet arranged on the second base frame, lateral movement of the first pallet relative to the second base frame is limited by a one-sided stop.

### FIELD

Embodiments of the present invention relate to a material processing system, in particular a laser processing system, with a pallet changing system.

### BACKGROUND

The state of the art in connection with pallet changing systems for material processing systems, in particular for laser processing systems, discloses numerous systems that enable the automatic feeding and removal of pallets to ensure efficient processing of workpieces. Pallet changing systems are of central importance in modern industrial material processing processes, as they make it possible to feed workpieces into the processing system quickly and precisely and to remove them again after processing.

CN112743246A also describes a pallet changing system that aims to improve the automation and efficiency of material handling. The system comprises a device for changing pallets between a warehouse and a processing station. The focus here is on reducing cycle times by optimising the simultaneous loading and unloading of pallets. While this system is able to improve the material flow, it shows weaknesses in terms of lateral stability of the pallets during transport. In particular, when handling heavy or unevenly distributed workpieces, the risk of pallets being pushed sideways out of their guides exists. This can lead to accidents. In addition, the system shows weaknesses in unambiguously identifying the pallet positions within the changer system, which can lead to possible mix-ups or inefficient processes.

Another relevant example of the state of the art is described in US5500507A1, which discloses a pallet changing system developed for laser processing systems. This system includes a pallet transfer mechanism that allows pallets to be moved between different stations. Whilst the system reduces processing times through automated pallet changes, it also presents problems in terms of process safety. In particular, when force is applied from the side, for example due to operating errors or external influences such as contact with a forklift truck, there consists of the risk of pallets slipping out of their guide in an uncontrolled manner, which is exemplified in FIG. 1. Such an incident can lead to considerable safety risks, in particular if large or heavy workpieces are loaded on the pallet. In addition, the system lacks a reliable way of monitoring the exact position of the pallets at all times, which can lead to delays and inefficient material flows in complex production processes and can also pose a safety risk.

Overall, the known pallet changing systems in the state of the art therefore have weaknesses that impair operational safety and efficiency.

### SUMMARY

Embodiments of the present invention provide a material processing system with a pallet changing system. The material processing system includes a first base frame, a first pallet and a second pallet capable of being positioned on the first base frame in a movable and height-adjustable manner relative thereto. Each of the first pallet and the second pallet has a support surface for receiving a plate-shaped workpiece. The material processing system further includes a first drive system, with which the first pallet and the second pallet are capable of being moved alternately from one another out of the first base frame into a material processing machine, which is positioned in alignment with a conveying direction of the pallet changing system, and back into the first base frame. The material processing system further includes a second base frame arranged in alignment with the first base frame in the conveying direction of the pallet changing system, and a second drive system connected to the second base frame, with which the first pallet and the second pallet are capable of being moved alternately from one another out of the second base frame into the first base frame and back into the second base frame. The second base frame has a first running rail and a second running rail running parallel to each other, on which the first pallet or the second pallet is capable of being displaced longitudinally in or out of a direction of the first base frame via rollers. A guide contour is arranged on the first running rail and/or on the second running rail for laterally guiding at least one roller of the rollers, and/or at least one lateral guide element is fixed relative to the second base frame or one of the first pallet and the second pallet arranged in the second base frame and projects beyond one of the first running rail and the second running rail at least in sections in such a way that, when a lateral force is applied with a force vector oriented perpendicular to a longitudinal extension of the first running rail or the second running rail from a first direction onto the first pallet or the second pallet arranged on the second base frame, lateral movement of the first pallet or the second pallet relative to the second base frame is limited by a one-sided stop against the at least one lateral guide element, thereby lateral displacement of the first pallet or the second pallet from the first running rail or the second running rail in the first direction is prevented.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a pallet changing system in two operating situations, each shown in a schematic cross-sectional representation;

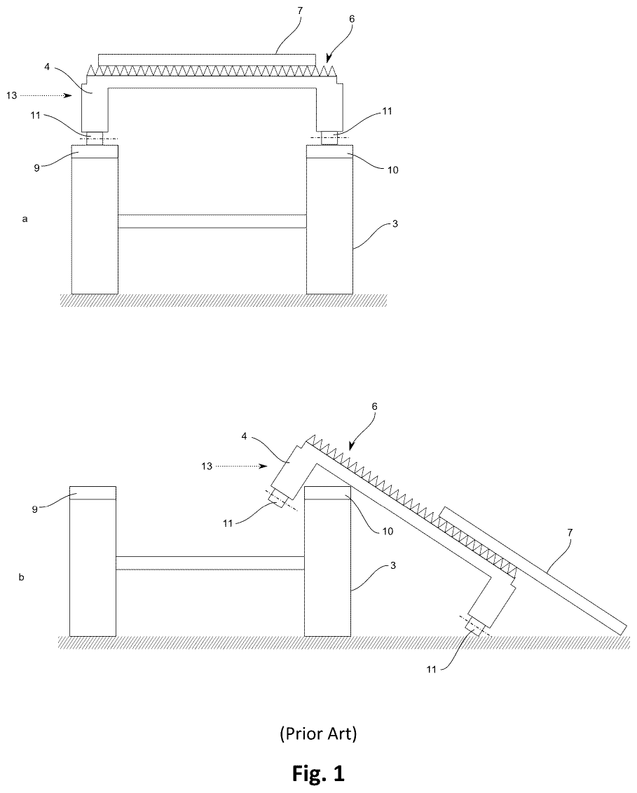

FIG. 2 illustrates a laser processing system and a pallet changing system with two frames in a perspective view, according to some embodiments;

FIG. 3 illustrates a first embodiment of a pallet changing system in a schematic cross-sectional view;

FIG. 4 illustrates a second embodiment of a pallet changing system in a schematic cross-sectional view;

FIG. 5 illustrates a third embodiment of a pallet changing system in a schematic cross-sectional view;

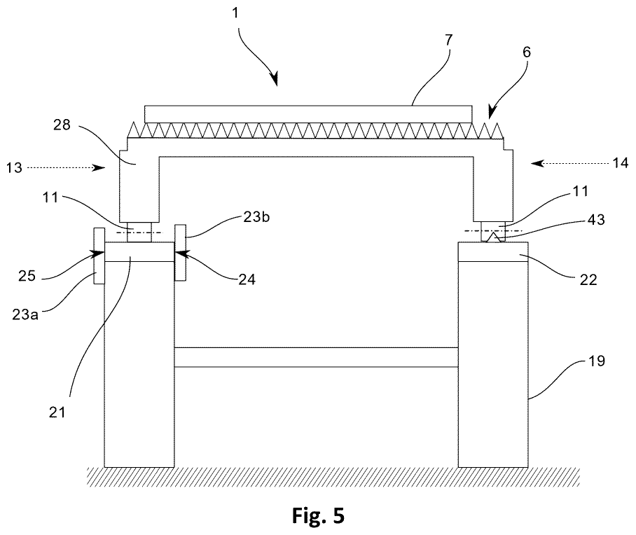

FIG. 6 illustrates a fourth embodiment of a pallet changing system in a schematic cross-sectional view;

FIG. 7 illustrates a fifth embodiment of a pallet changing system in a schematic cross-sectional view;

FIG. 8 illustrates a sixth embodiment of a pallet changing system in a schematic cross-sectional view;

FIG. 9 illustrates a seventh embodiment of a pallet changing system in a schematic cross-sectional view;

FIG. 10 illustrates schematically a sensor system for identifying three different pallets in a pallet changing system according to some embodiments;

FIG. 11 illustrates a sensor system for identifying three different pallets in a pallet changing system in a perspective design view, according to some embodiments;

FIG. 12 illustrates an eighth embodiment of a pallet changing system in a cross-sectional view;

FIG. 13 illustrates a ninth embodiment of a pallet changing system in a schematic cross-sectional view;

FIG. 14 illustrates a tenth embodiment of a pallet changing system in a schematic cross-sectional view;

FIG. 15 illustrates an eleventh embodiment of a pallet changing system in a schematic cross-sectional view;

FIG. 16 illustrates a twelfth embodiment of a pallet changing system in a schematic cross-sectional view; and

FIG. 17 illustrates various guide contours for lateral guidance of rollers on a track, each shown in a schematic cross-sectional view, according to some embodiments.

### DETAILED DESCRIPTION

Embodiments of the present invention provide a material processing system, in particular a laser processing system, with a pallet changing system with two stations, which avoids or at least reduces the problems known from the state of the art.

According to some embodiments, a material processing system, in particular a laser processing system, with a pallet changing system comprising a first base frame, a first pallet and at least one second pallet, which can be positioned on the first base frame in a movable and height-adjustable manner relative to the latter, wherein the at least two pallets each have a support surface for receiving a plate-shaped workpiece, a first drive system, by which the pallets can be moved alternately from one another out of the first base frame into a material processing machine, which is positioned in alignment with the conveying direction of the pallet changing system, and back into the first base frame, wherein the pallet changing system comprises a second base frame, which is arranged in alignment with the first base frame in the conveying direction of the pallet changing system, and furthermore has a second drive system which is connected to the second base frame and by which the pallets can be moved alternately from the second base frame into the first base frame and back into the second base frame, wherein the second base frame has a first running rail and a second running rail running parallel thereto, on which a pallet can be displaced longitudinally in or out of the direction of the first base frame via rollers, wherein a guide contour is arranged on the first running rail and/or on the second running rail for laterally guiding at least one, preferred a plurality of the rollers and/or wherein at least one lateral guide element is provided which is fixed relative to the second base frame or a pallet arranged in the base frame and projects beyond one of the running rails at least in sections.

This pallet changing system with two base frames and one drive system per moving pallet enables greater flexibility and efficiency in the material flow. Thanks to the aligned arrangement of the two base frames, one pallet can be inserted into the processing machine while another pallet is simultaneously moved from the second base frame onto the first base frame. This leads to a considerable reduction in cycle times when changing pallets. The system can work continuously, which increases overall productivity.

A substantial advantage of the pallet changing system described is the use of guide contours on the rails. These guide contours ensure precise lateral guidance of the pallet rollers, which brings several decisive technical advantages.

Firstly, the lateral guidance of the rollers ensures exact positioning of the pallets during transport between the base frames and the material processing machine. This prevents the pallets from slipping or tilting out of their intended position due to lateral forces, such as during acceleration or deceleration of the transport. This leads to significantly higher operational safety and reliability of the system, in particular at high speeds or with heavy loads.

Another substantial advantage of the guide contours consists in the reduction of wear on the rails and rollers of the pallets. The targeted guidance along the contours distributes the load evenly over the rollers, avoiding point loads. This extends the service life of the system components and significantly reduces maintenance costs.

In addition, the precise lateral guidance enables trouble-free movement of the pallets even under demanding operating conditions, such as with unevenly distributed loads or in environments with vibrations. This contributes to greater process stability by ensuring that the pallets reach their final positions in the base frames or the material processing machine reliably and with repeatable accuracy.

As an alternative or additionally, at least one lateral guide element may be provided which is fixed relative to the second base frame or a pallet arranged in the base frame and projects beyond one of the running rails at least in sections on its first longitudinal extension side in such a way that, when a lateral force is applied with a force vector orientated perpendicular to the longitudinal extension of the running rails from a first direction onto a pallet arranged on the second base frame, a lateral movement of the pallet relative to the second base frame is at least limited by a one-sided stop against the side guide element and a lateral displacement of the pallet from the running rails in the first direction is prevented.

The substantial advantage of this pallet changing system is that it increases safety when handling pallets. In particular, it prevents a pallet from unintentionally falling out of a frame, which could be caused by lateral forces such as those exerted by a forklift truck. While the first base frame of the pallet changing system is usually integrated into an automatic loading and unloading device, the second base frame can be used to load special workpieces, for example heavy workpieces, onto the pallet or remove them from the pallet manually or using a crane or forklift truck. The protective mechanism minimizes the risk of a pallet being displaced sideways and lifted out of the frame if the fork of a forklift truck accidentally hits the side of the pallet instead of properly reaching underneath it. This significantly reduces the risk of infringement and accidents and ensures safer handling of the pallets. The one-sided pallet lift-out protection now ensures that a pallet cannot slide off the frame of the base frame when lateral force is applied. This not only offers a considerable safety advantage for the operating personnel, but also protects the workpieces being transported on the pallet. Accidental movement of the pallet could damage the workpieces or cause accidents.

### PALLET CHANGING SYSTEM

For the purposes of this patent application, a pallet changing system is a device which is used for the automated handling and exchange of pallets within a material processing system, in particular a laser processing system. The pallet changing system makes it possible to transport pallets carrying workpieces between different positions, in particular between a position within the base frame of the pallet changing system and a position in the processing machine.

The pallet changing system consists of a first base frame, in which preferably at least two pallets can be positioned one above the other on corresponding support surfaces. The base frame can be moved in height, in particular electrically or hydraulically, so that the two pallets can each be positioned at the height of the processing plane of the material processing machine. The pallets can be moved by a drive system, which can be arranged on the pallet changing system or on the processing machine, either into the processing machine or out of it back into the base frame. Two parallel rails are provided to support the pallets within the frame, on which the pallets can be moved longitudinally by means of rollers. By adjusting the height of the base frame, either one or the other pallet can be transported out of the first base frame into the processing machine or from the processing machine back into the base frame.

The pallet changing system further comprises a second base frame, which is arranged in alignment with the first base frame. The second base frame is equipped with a drive system that can move a pallet from the second base frame into the first base frame and back. The second base frame is also equipped with two parallel rails on which the pallets are moved in the longitudinal direction. The parallel design of the two base frames enables the pallets to be transported efficiently between the first and second base frame and the processing machine in a synchronised movement.

### BASE FRAME

For the purposes of this patent application, a base frame is a load-bearing basic structure which holds and guides the pallets of the pallet changing system and stabilises their position during changing and transport. Preferably, the base frame is formed from a robust material, such as steel and/or aluminium, in order to withstand the forces acting during operation.

The structure of the base frame comprises two parallel running rails on which the pallets are guided and moved by rollers. These running rails are firmly connected to the base frame or are part of the base frame and ensure precise and low-friction movement of the pallets. The base frame can also be equipped with lateral guide elements that prevent the pallets from being lifted or displaced from the rails when lateral forces are applied.

In one embodiment, the base frame consists of a single robust block with integrated running rails, creating a stable and durable structure. Alternatively, the frame of the base frame can be modular so that individual segments of the base frame can be replaced or maintained without affecting the entire structure. In another preferred embodiment, the frame of the base frame can be equipped with additional damping elements to minimise vibrations or shocks during operation.

### PALLET

For the purposes of this patent application, a pallet is a support element which is used to transport and position workpieces, in particular flat, plate-shaped materials, in a material processing machine and a pallet changing system. The pallet preferably has a closed frame in which support bars are arranged at regular intervals, the support tips of which form a flat support surface in order to support the workpiece safely and stably during the entire transport and/or machining process. It is preferred that the pallet has rollers on a side surface or on the underside of the pallet frame so that it can be guided longitudinally on rails in a pallet changing system, wherein it is moved via the rollers.

The pallet can also be fitted with lateral guide elements that prevent the pallet from being lifted or displaced from the running rails of the base frame when lateral forces are applied.

### DRIVE SYSTEM

For the purposes of this patent application, a drive system is a device or an arrangement of components that is used to move one or more pallets between different positions within the pallet changing system and the material processing machine. The drive system is responsible, for example, for transporting the pallets from a base frame into the material processing machine or from the material processing machine back into the base frame and between the base frames.

The drive system preferably comprises a motor that is either electrically, hydraulically or pneumatically operated, as well as a transmission unit that transmits the drive force of the motor to the pallets. This transmission unit may consist of a combination of gears, belts, chains or spindles that are connected to the pallets or their carrier system to enable their movement along the rails. A control unit can also preferably be part of the drive system to coordinate the movements of the pallets, define precise stopping points and avoid potential collisions. In addition, sensors can be integrated to monitor the position of the pallets and provide feedback to the control unit.

Conceivable embodiments of the drive system comprise different types of motors, wherein electric motors are preferred as they offer high precision and controllability. A possible embodiment of the drive system could also be a linear drive, which enables direct and efficient movement of the pallets. Alternatively, the drive system can be coupled to the pallet via a chain or belt arrangement, which provides a flexible and durable movement solution.

### RUNNING RAIL

For the purposes of this patent application, a running rail is an elongated element attached to the frame of a pallet changing system, which primarily serves as a support surface for the pallet. The running rail thus enables the pallet to be moved along the base frame. It bears the weight of the pallet and the workpieces on it.

Rollers are arranged between the running rail and the pallet to reduce friction. These can either be attached to the pallet and moved in translation with it, or they can be fixed to the running rail in a rotatable manner so that the pallet is moved over the rollers of the running rail.

The running rail can be flat or provided with a contoured track or a guide rail to serve either only as a support surface or additionally as a guide for the rollers of the pallet. In cases where a guiding function is desired, the contour of the running rail or the additional guide rail ensures that the pallet is held precisely on the defined path of movement, which increases stability and safety during operation. In a preferred embodiment, the running rail or the additional guide rail can have a special contour, for example in a U-shape, which stabilises the rollers and the pallet laterally and guides their movement in the longitudinal direction. Alternatively, the contour of the running rail or the guide rail can be designed as a square, rectangular, round or oval projection that engages in the profiled running surface of the rollers. This contour or guide rail makes it possible to move the pallet precisely along the running rail while avoiding lateral displacement. Alternatively, the running rail could also have an L-shaped or other profiled structure that allows the rollers to be guided laterally and keeps the pallet on its track. The surface of the track can also be coated to reduce wear and minimise friction.

### GUIDE CONTOUR

For the purposes of this patent application, a guide contour is a specially shaped structure on the running rails of the pallet changing system which serves to hold the rollers of the pallets precisely in their lateral position during transport and to ensure stable and safe movement of the pallets along the running rails. The guide contour ensures that the pallets remain reliably on track without moving from their intended path in the event of forces acting on the sides of the pallets.

The function of the guide contour consists of ensuring lateral guidance of the rollers so that the pallets can be moved stably along the rails regardless of external influences such as vibrations or uneven load distribution. This increases the operational reliability of the system and ensures that the pallets reach their intended positions precisely and with repeat accuracy. The guide contour also helps to prevent the pallet from tilting or deviating from the conveying direction, resulting in smooth and trouble-free operation of the pallet changing system.

The guide contour is advantageously integrated into the running rails and can be either a protruding rib or a special groove that runs along the longitudinal direction of the running rails. This contour interacts with the lateral surfaces of the rollers to ensure that the rollers and thus the entire pallet are guided precisely. Preferably, the guide contour consists of a wear-resistant material to ensure a long service life. Conceivable materials for the guide contour comprise hardened steel, which offers high resistance to mechanical stress, or alternative materials such as high-strength plastics or composite materials, which advantageously enable lower friction and therefore quieter and more efficient operation.

In an alternative embodiment, the guide contour can consist of a separate guide element that is applied to or attached to the running rail. This solution offers the advantage that the guide contour can be easily replaced in the event of wear without having to replace the entire running rail. Such separate guide elements could also consist of modular components that can be flexibly adapted to different requirements, such as different roller sizes or load scenarios.

### LATERAL GUIDE ELEMENT

For the purposes of this patent application, a lateral guide element is a device which is firmly connected to the frame of a base frame or to the frame of a pallet and serves to limit or completely prevent lateral movement of the pallet within or on the running rails. The side guide element projects beyond the longitudinal sides of the rails, at least in sections, so that a pallet is stopped or held back when lateral force is applied, which is caused by a force vector orientated perpendicular to the rails. This prevents the pallet from falling or slipping off the running rail, in particular in the event of lateral contact.

The function of the side guide element thus consists of holding the pallet in one position within the pallet changing system by minimising or completely restricting the lateral freedom of movement of the pallet. This increases the safety and reliability of the system, as the risk of pallets unintentionally slipping or being lifted off the rail is greatly reduced.

It is preferred that the side guide element is made from a formed sheet metal, which enables cost-efficient production and at the same time ensures sufficient stability and strength. It is firmly attached to the base frame of the pallet changing system or to the frame of the pallet, either by material bonding, force-fit or form-fit, in order to ensure a permanent connection. Conceivable embodiments of the side guide element further comprise one-sided or two-sided variants, wherein the element either projects over only one side of the running rail or both sides in order to be effective when forces are applied from different directions. Single-sided versions prevent lateral movement of the pallet in one direction only, while double-sided versions limit movement in both directions. Both variants help to stabilise the pallet, wherein the double-sided version offers even greater protection, in particular in environments where pallets are frequently approached or moved from different sides.

It is possible for a side guide element to be formed in one piece, in particular monolithically. This means that the side guide element consists of a single piece of material. This monolithic design offers the advantage of high structural integrity and strength, as there are no joints or connection points that could represent potential weak points. In addition, the monolithic design reduces maintenance requirements as there are no individual parts to wear out or become loose that would need to be regularly checked or replaced.

However, it is also conceivable to design a side guide element in several parts. In this case, the side guide element consists of several components that are connected to each other. This multi-part design offers the advantage of greater flexibility in design and assembly. Individual parts of the side guide element can be customised to meet specific requirements, for example by using different materials for different sections. For example, a part of the side guide element that can come into direct contact with the pallet could be made of a material that is abrasion-resistant, while other parts consist of lighter or more cost-effective materials.

A multi-part design also makes it easier to repair and replace individual parts. If a part of the side guide element is damaged, it is not necessary to replace the entire element, only the affected component. In addition, a multi-part design can have a modular structure, which further simplifies replacement or adaptation to different system requirements. This flexibility can be an advantage in particular during maintenance and operation, as individual modules can be replaced or modified as required without having to shut down the entire system.

Preferably, the side guide element is arranged on the side surface of the base frame or pallet frame inside the base frame or pallet. In this way, the pallet remains easily accessible from the outside by a machine operator. In this way, the side guide element does not hinder the operator when, for example, cut workpiece parts are to be manually removed from the pallet or the support bars of the pallet are to be cleaned.

According to a further embodiment of the invention, the first lateral guide element projects beyond at least one of the running rails, at least in sections on its first longitudinal extension side and its second longitudinal extension side, in such a way that, when a lateral force is applied to a pallet from a first direction or from a second direction with a force vector orientated perpendicular to the longitudinal extension of the running rails, lateral movement of the pallet relative to the first frame is at least limited by a stop on both sides against the first lateral guide element and lateral displacement of the pallet from the running rails in the first direction and the second direction is prevented. The pallet lift-out protection on both sides, which intercepts lateral forces from both the first and the second direction, provides even more comprising protection than the one-sided protection. This increases the safety and reliability of the pallet changing system.

In another embodiment of the invention, a first lateral guide element is provided which is positioned relative to the first base frame or a pallet arranged in the base frame and projects beyond the second running rail at least in sections on one of its longitudinal sides in such a way that, when a lateral force is applied to a pallet from a second direction with a force vector orientated perpendicular to the longitudinal extension of the running rails, lateral movement of the pallet relative to the first base frame is at least limited by a one-sided stop against the second lateral guide element and lateral displacement of the pallet from the running rails in the second direction is prevented. The two-sided pallet lift-out protection on both running rails further increases the stability of the pallet. This offers maximum protection against the pallet falling out unintentionally, even when strong forces are applied or in situations where the pallet is used intensively. The increased operational safety and prevention of accidents or damage to pallets and workpieces are significant advantages.

The first side guide element and/or the second side guide element can be formed from sheet metal. By using side guide elements made of sheet metal, the pallet changing system offers a cost-efficient yet robust solution. Sheet metal is a readily available and economical material that still provides the necessary stability to hold the pallets securely. Manufacturing from sheet metal also makes it possible to flexibly adapt the side guide elements to different requirements without the need for expensive materials or complex processes for production.

The first side guide element and/or the second side guide element can be attached to the second base frame in a material-fit and/or force-fit and/or form-fit manner. The different types of attachment of the side guide elements (material-fit, force-fit or form-fit) offer flexible adaptation to different requirements of the pallet changing system. This makes it possible to attach the side guide elements to the frame in a stable and secure manner.

The first side guide element and/or the second side guide element can have a cross-sectional contour that is either double-L-shaped or based on the number six. The special cross-sectional contour of the side guide elements, which is either double-L-shaped or based on the number six, provides an optimum shape for effectively securing pallets against lateral forces.

This shape ensures increased stability of the side guide element, which is advantageous in situations with strong lateral forces. At the same time, the simple geometric shape enables cost-efficient production and assembly of the guide elements.

In another embodiment of the invention, in addition to the first pallet and the second pallet, at least one third pallet is provided in the pallet changing system, wherein
the first pallet has a first sensor target which can be detected by a first sensor, which is arranged in a fixed position relative to the first base frame, and by a second sensor, which is arranged in a fixed position relative to the second base frame, and
the first pallet has a second sensor target, which can be detected by a third sensor, which is arranged in a fixed position relative to the first base frame, and by a fourth sensor, which is arranged in a fixed position relative to the second base frame, and
the second pallet has a third sensor target which can be detected by the first sensor, which is arranged in a fixed position opposite the first base frame, and by the second sensor, which is arranged in a fixed position opposite the second base frame, and
the second pallet has a fourth sensor target which can be detected by the third sensor, which is arranged in a fixed position relative to the first base frame, and by the fourth sensor, which is arranged in a fixed position relative to the second base frame, and
the third pallet has a fifth sensor target which can be detected by the first sensor, which is arranged in a fixed position opposite the first base frame, and by the second sensor, which is arranged in a fixed position opposite the second base frame, and
the third pallet has a sixth sensor target which can be detected by the third sensor, which is arranged in a fixed position relative to the first base frame, and by the fourth sensor, which is arranged in a fixed position relative to the second base frame, wherein
the first sensor target and the second sensor target are configured such that sensor signals can be generated at the sensors of the first base frame and the sensors of the second base frame which enable the first pallet to be unambiguously identified, and
the third sensor target and the fourth sensor target are configured such that sensor signals can be generated at the sensors of the first base frame and the sensors of the second base frame which enable the second pallet to be unambiguously identified, and
the fifth sensor target and the sixth sensor target are configured in such a way that sensor signals can be generated at the sensors of the first base frame and the sensors of the second base frame, which enable the third pallet to be unambiguously identified.

The sensor-based identification system makes it very easy and cost-effective to automatically recognise the position of each pallet within the pallet changing system: this makes it much easier to operate and control the system, as it is always clear which pallet is where. This avoids mix-ups and ensures an efficient material flow. In automated production processes in particular, this exact position detection is crucial for optimising the operation of the pallet changing system and ensuring safety.

In particular, the sensor system can also preferably be configured such that only the first or the second sensor outputs a signal to the control device, thus recognising that the first pallet is located in the first or in the second base frame. The sensor targets are then configured in such a way that they generate the corresponding sensor signals. In this case, sensor targets can also be configured in such a way that they do not generate a sensor signal, wherein no sensor signal then also represents information that can be analysed by the control device. If only the third or fourth sensor emits a signal to the control device, it is recognised that the second pallet is in the first or second base frame. If both the first and the third sensor output a signal to the control device, then the third pallet is located in the first base frame. If both the second and fourth sensors output a signal to the control device, the third pallet is in the second base frame.

### SENSOR TARGET

For the purposes of this patent application, a sensor target is a specific structure or component that is used to be detected by a sensor to unambiguously determine the position or identity of an object, such as a pallet, within the pallet changing system. A sensor target can have various physical properties that can be detected by the corresponding sensor. These properties can be optical, mechanical, electrical or magnetic in nature and enable the pallet to be recognised and identified within the pallet changing system.

Optical sensor targets are preferably based on a structure that reflects or absorbs light and can therefore be recognised by an optical sensor. This can be achieved by using special colours, patterns or surface coatings that are detected by the sensor in the visible or infrared spectral range. An optical sensor target can advantageously have a special marking or a reflective surface that enables the sensor to determine the exact distance and thus the position of the pallet.

Mechanical sensor targets are characterised by the fact that they have a physical elevation or a specific geometry that is detected by a mechanical detector. It is preferred to use an elevation or indentation on the pallet which, through contact with the sensor, provides unambiguous feedback on the position or presence of the pallet. This mechanical design offers the advantage of a robust and resistant construction that functions reliably even under harsh conditions.

Electrical sensor targets can contain a conductive structure that interacts with an electrical sensor. This design prefers to utilise the conductivity of the material, which informs the inductive or capacitive sensor of the presence or exact position of the pallet.

Magnetic sensor targets consist of magnetic materials or contain permanent magnets that are detected by a magnetic field-sensitive sensor. This embodiment offers the advantage that no direct line of sight between the sensor and the sensor target is required, allowing the system to work reliably even when the pallet is concealed. Preferably, the sensor target can consist of a ferromagnetic material that is used in combination with a magnetoresistive or Hall effect sensor to accurately determine the position of the pallet.

The sensor targets can also be configured in such a way that they do not cause a sensor signal at a corresponding sensor, wherein no sensor signal then also represents information that can be analysed by the control device. If, for example, an elevation or depression on the pallet is used as a sensor target that provides unambiguous feedback on the position or presence of the pallet through contact with the sensor, a flat surface on the pallet, i.e. an area without an elevation or depression, can also act as a sensor target.

### SENSORS

For the purposes of this patent application, a sensor is a device or apparatus that can detect physical characteristics of a sensor target and convert them into an electrical signal that is used to determine the position, identity or a state of a pallet within the pallet changing system. The sensor is responsible for reliably detecting the relevant properties of the sensor target, be they optical, mechanical, electrical or magnetic features, and passing this information on to the system's control unit to enable the exact positioning and transport of the pallets.

A sensor can be selected from the group of optical sensors, mechanical sensors, electrical sensors and/or magnetic sensors.

In this context, it can also be advantageous if the first sensor and/or the second sensor and/or the third sensor and/or the fourth sensor are each designed as distance measuring sensors. The design of the sensors as distance measuring sensors enables precise detection of the positions of the pallets without having to physically touch them. This reduces wear on the sensors and ensures a low-maintenance and durable solution. In addition, distance sensors can work reliably even under difficult environmental conditions, such as in dusty or dirty industrial environments, which further increases operational safety.

Furthermore, it is preferred that the first sensor target and/or the second sensor target are/is formed as an elevation from a plane of the first pallet, and/or the third sensor target and/or the fourth sensor target are/is formed as an elevation from a plane of the second pallet, and/or the fifth sensor target and/or the sixth sensor target are/is formed as an elevation from a plane of the third pallet. By forming the sensor targets as elevations from the plane of the pallets, a simple, robust and reliable way of identifying the position of the pallets is created. These protrusions are resistant to external influences and cannot be damaged as easily as more sensitive electronic components. This increases the service life of the system and ensures reliable pallet identification in the long term.

Furthermore, in a preferred further embodiment of the invention, it may be provided that the first sensor target and/or the second sensor target are/is formed as a separate component, and/or the third sensor target and/or the fourth sensor target are/is formed as a separate component, and/or the fifth sensor target and/or the sixth sensor target are/is formed as a separate component. The design of the sensor targets as separate components offers the advantage that they can be replaced or adapted easily and cost-effectively. In the event of a defect or damage, the sensor target can be replaced quickly without having to replace the entire pallet. This reduces maintenance costs and increases the flexibility of the system, as the sensor targets can be adapted to different requirements.

Finally, it may also be advantageous if the pallet changing system comprises a control unit which is connected to the first drive system and the second drive system in such a way that the transport of the pallets from or to the respective frames can be controlled, wherein the control unit is configured in such a way that a pallet located on the first frame can be transported simultaneously in the direction of the material processing machine by means of the first drive system, and a pallet located on the second frame by means of the second drive system. The control unit, which enables the simultaneous movement of two pallets, considerably speeds up the pallet changing process. Both pallets can be transported at the same time, which shortens throughput times and increases the productivity of the system.

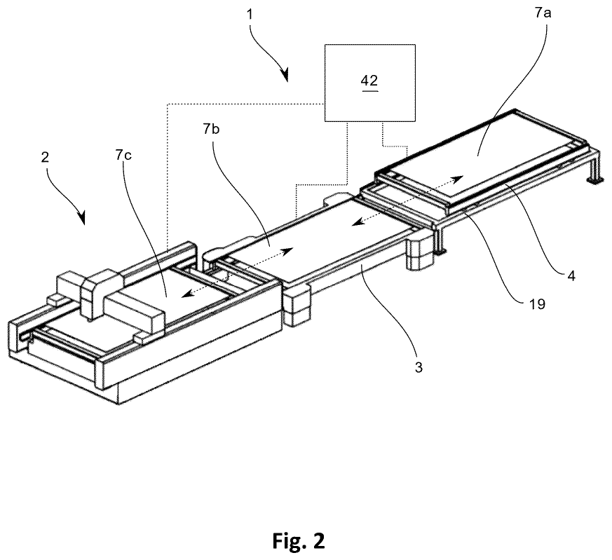

FIG. 2 shows a perspective view of a laser processing system for material processing of plate-shaped workpieces 7a, 7b, 7c, which preferably consist of metal. In the embodiment shown, the laser processing system comprises a laser cutting machine 2. Alternatively, the laser processing system can also comprise a plasma cutting machine or a combined punching/laser cutting machine. The laser processing machine 2 comprises a cutting unit with a laser processing head that can be moved in a horizontal plane of movement in order to cut the plate-shaped workpiece 7a.

A pallet changing system 1 for at least three pallets 4, 5, 28 is arranged adjacent to the laser processing machine 2. The pallet changing system 1 is configured in such a way that it can transport the pallets 4, 5, 28 back and forth between the pallet changing system 1 and the laser processing machine 2. Preferably, the first base frame 3 of the pallet changing system 1 is arranged next to a store for raw material, from which the material can be loaded onto a pallet 4, 5, 28 using a suction gripper or a gripper system, for example. The pallet changing system 1 can also be supplemented with a handling device that unloads cut workpiece parts from the support surface 6 of a pallet 4, 5, 28.

In the laser processing machine 2, the plate-shaped workpiece 7c located on a pallet 4, 5, 28 is cut by means of the laser processing head to obtain laser-cut products. In the course of the cutting process, residual parts or a residual grid are produced in addition to the products. After the machining process, the pallet 4, 5, 28 is transported from the laser processing machine 2 back to the pallet changing system 1, where the products and/or residual parts or the residual grid can be removed manually or by a handling device.

The base frame 3 of the pallet changing system 1 has a lifting device that enables the pallets 4, 5, 28 to be moved vertically in order to bring a pallet 4, 5, 28 into a working plane from which it can be moved into or out of the laser processing machine 2. The lifting device may preferably comprise hydraulic cylinders, a ball screw, a roller chain drive, an electric cylinder or linear motors.

The pallet changing system 1 shown in FIG. 2 comprises a first base frame 3, on which a first pallet 4 and at least one second pallet 5 can be movably positioned. The pallets 4 and 5 each have a support surface 6 for holding a plate-shaped workpiece 7, for example metal plates, which are processed in the laser processing machine 2.

The system is equipped with a first drive system 8, which can be connected to the first base frame 3 or arranged in the laser processing machine 2 and configured in such a way that the pallet 4 or 5 located in the working plane can be moved from the first base frame 3 into the material processing machine 2. This appendix is positioned in alignment with the conveying direction of the pallet changing system 1 so that the pallets can be transported back into the first base frame 3 after processing. The first base frame 3 has a first running rail 9 and a parallel second running rail 10 at the top. Two further running rails (not visible) are arranged vertically offset to the first base frame 3. The pallets 4 and 5 can be moved longitudinally into or out of the laser processing machine 2 on these running rails using rollers 11.

In addition, the pallet changing system 1 comprises a second base frame 19, which is arranged in alignment with the first base frame 3 in the conveying direction of the pallet changing system 1. The second base frame 19 is equipped with a second drive system 20, which transports the pallets 4 and 5 alternately between the first base frame 3and the second base frame 19. The second base frame 19 also has a first running rail 21 and a parallel second running rail 22, via which the pallets 4 and 5 can be moved longitudinally in or out of the direction of the first base frame 3 with the aid of the rollers 11.

The pallet changing system 1 or the laser processing machine 2 also has a control unit 42, which is connected to the first drive system 8 and the second drive system 20 in such a way that the transport of the pallets 4, 5, 28 from or to the respective base frames 3, 19 can be controlled. The control unit 42 is configured in such a way that a pallet 4, 5, 28 located on the first base frame 3 can be transported simultaneously in the direction of the material processing machine 2 by means of the first drive system 8 and a pallet 4, 5, 28 located on the second base frame 19 can be transported simultaneously in the direction of the material processing machine 2 by means of the second drive system 20.

This configuration enables the pallets to be changed smoothly and efficiently between the base frames and the processing machine, which shortens processing times and increases productivity.

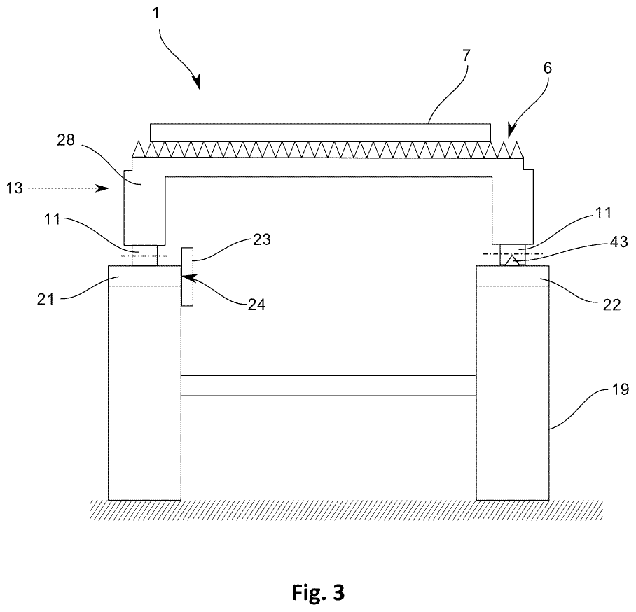

FIG. 3 now shows a second base frame 19 of the pallet changing system 1 with one-sided pallet lift-out protection on a running rail 21. Here, a pallet 4, 5, 28 has a substantially U-shaped basic shape in cross-section, wherein rollers 11 are arranged between the running rails 21, 22 and the free legs of the pallet 4, 5, 28 in order to enable low-friction movement of the pallet 4, 5, 28 relative to the rails 21, 22. In this case, the rollers 11 are mounted on the free legs of the pallets 4, 5, 28. In the embodiment shown, the running rails 21,22 are designed as separate components and are connected to the base frame 19, but they can also be designed in one piece with the base frame 19.

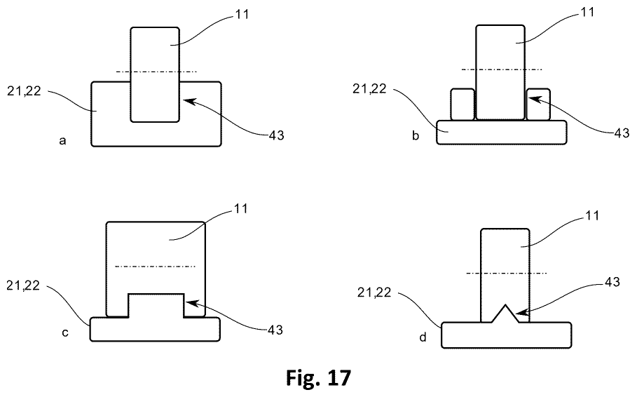

FIG. 17 shows various guide options for forming a guide contour 43 on the first running rail 21 and/or on the second running rail 22 for laterally guiding at least one, preferred a plurality of the rollers 11. The guide contour 43 can, for example, be formed as a groove in a running rail 21,22, in which the roller 11 or the rollers 11 is/are guided, as shown in figure a of FIG. 17. This groove can also be formed by two guide elements which are attached to the running rail 21,22, as can be seen in figure b of FIG. 17. A further embodiment of the guide contour 43 is shown in figure c of FIG. 17, in which the cylindrical rollers 11 each have a circumferential groove which is guided on a rail formed on the running rail 21,22. This groove can also be triangular in shape, as sketched in figure d of FIG. 17.

It can also be seen from FIG. 3 that the pallet changing system 1 is equipped with a one-sided pallet lift-out protection on a running rail 21, 22 of the base frame 19. A lateral guide element 23 is provided which, on the one hand, is fixed relative to the second base frame 19 and, on the other hand, projects beyond at least one of the running rails 21, 22 at least in sections on its first longitudinal extension side 24 in such a way that, when a lateral force is applied with a force vector orientated perpendicular to the longitudinal extension of the running rails 21,22 from a first direction 13 onto a pallet 4, 5, 28, lateral movement of the pallet 4, 5, 28 relative to the second base frame 19 is at least limited by a one-sided stop against the lateral guide element 23 and lateral displacement of the pallet 4, 5, 28 from the running rails 21, 22 in the first direction 13 is prevented.

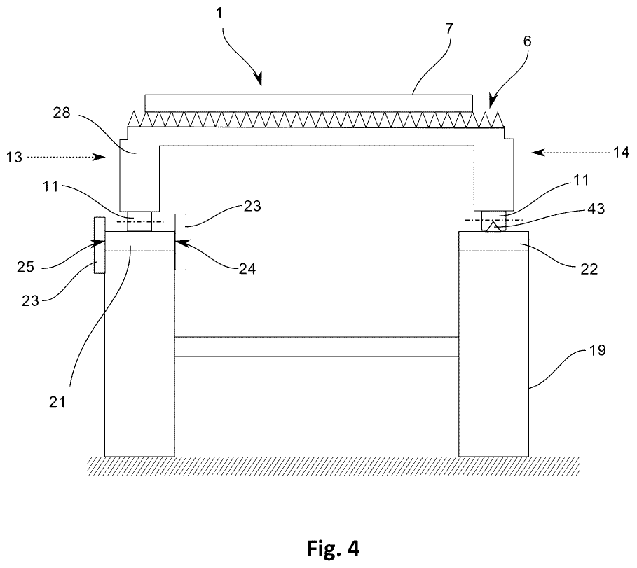

Furthermore, the pallet changer system 1 can also be provided with a two-sided pallet lift-out protection on a running rail 21, 22 of the second pallet changer or base frame 19. FIG. 4 shows accordingly that the third lateral guide element 23 projects beyond at least one of the running rails 21, 22 at least in sections on its first longitudinal extension side 24 and its second longitudinal extension side 25 in such a way that, when a lateral force is applied with a force vector orientated perpendicular to the longitudinal extension of the running rails 21,22 from a first direction 13 or from a second direction 14 on a pallet 4, 5, 28, lateral movement of the pallet 4, 5 relative to the second frame 19 is at least limited by a stop on both sides against the third lateral guide element 23 and lateral displacement of the pallet 4, 5, 28 from the running rails 21, 22 in the first direction 13 and the second direction 14 is prevented.

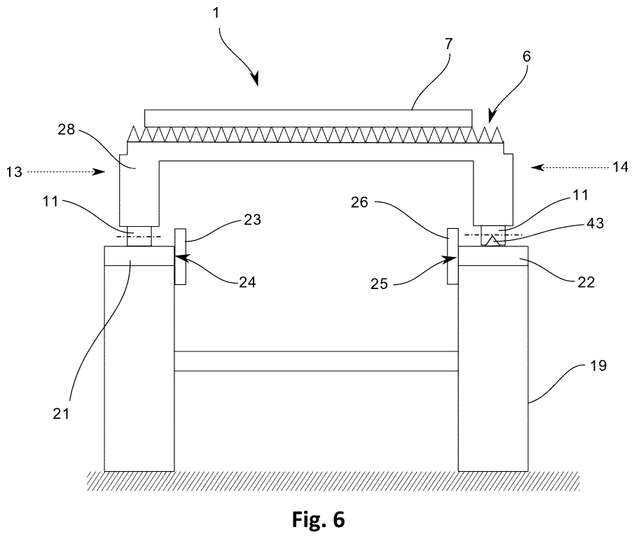

Of course, it can also be provided that the pallet changing system 1 is equipped with two-sided pallet lift-out protection on both running rails 21, 22 of the second pallet changer or base frame 19. Accordingly, it can be seen from FIG. 6 that a lateral guide element 23 is provided which, on the one hand, is fixed relative to the second base frame 19 and, on the other hand, projects beyond the first running rail 21 at least in sections on one of its longitudinal extension sides 24, 25 in such a way that, when a lateral force is applied with a force vector orientated perpendicular to the longitudinal extension of the running rails 21,22 from a first direction 13 onto a pallet 4, 5, 28, lateral movement of the pallet 4, 5, 28 relative to the second frame 19 is at least limited by a one-sided stop against the lateral guide element 23 and lateral displacement of the pallet 4, 5, 28 from the running rails 21, 22 in the first direction 13 is prevented. Furthermore, at least one further lateral guide element 26 is provided which, on the one hand, is fixed relative to the second base frame 19 and, on the other hand, projects beyond the second running rail 22 at least in sections on one of its longitudinal sides 24, 25 in such a way that, when a lateral force is applied with a force vector orientated perpendicular to the longitudinal extension of the running rails 21,22 from a second direction 14 onto a pallet 4, 5, 28, lateral movement of the pallet 4, 5, 28 relative to the second frame 19 is at least limited by a one-sided stop against the fourth lateral guide element 26 and lateral displacement of the pallet 4, 5, 28 from the running rails 21, 22 in the second direction 14 is prevented.

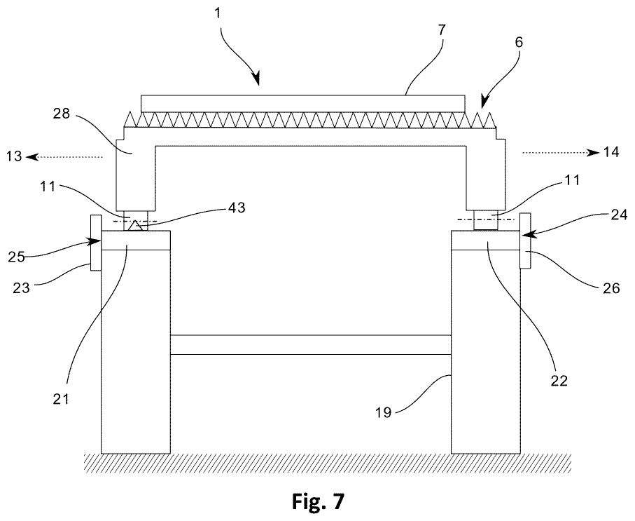

In the embodiment shown in FIG. 6, the side guide elements 23, 26 are arranged on the inside of the running rails 21, 22 in relation to the base frame 19. It is of course also possible for the side guide elements 23, 26 to be arranged on the outside of the running rails 21, 22 in relation to the base frame 19, as can be seen in FIG. 7.

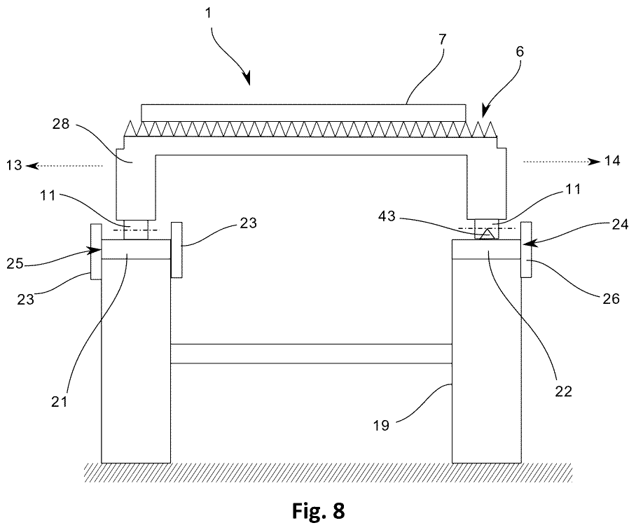

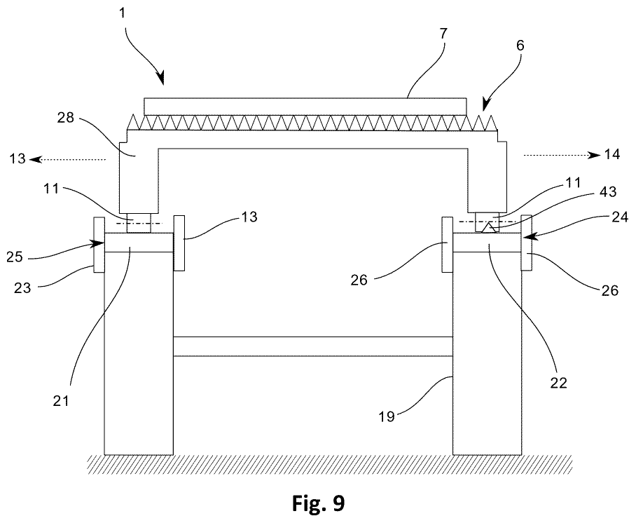

It is also possible to combine the embodiments of FIGS. 3-4 with each other in order to further improve the lift-out protection. A corresponding embodiment is sketched in FIG. 8. Following this basic idea, it is also possible to provide a lateral guide element 23, 26 that is effective on both sides on both running rails 21, 22, as shown in FIG. 9.

In the embodiments shown, the first side guide element 23 and the second side guide element 26 are formed from a moulded sheet metal and are attached to the base frame 19 by means of screw connections.

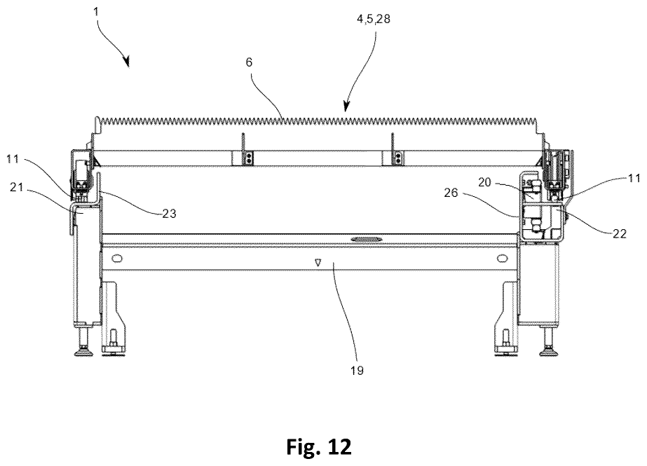

FIG. 12 shows that the side guide element 26 has a cross-sectional contour 27 representing the number six and the side guide element 23 has a double-L-shaped cross-sectional contour 27.

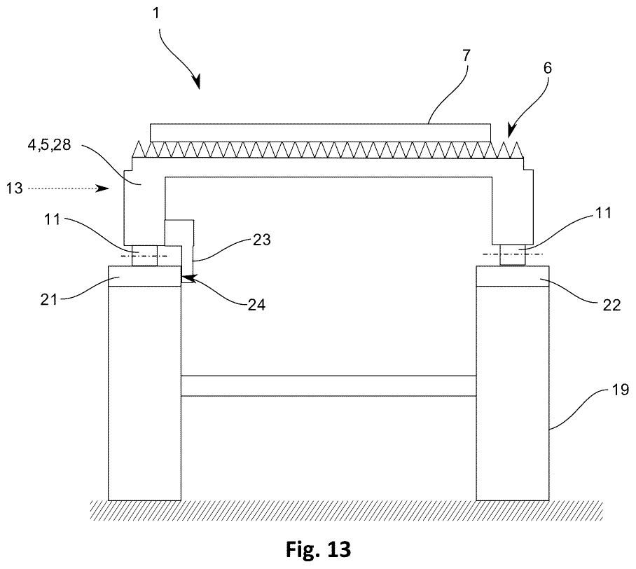

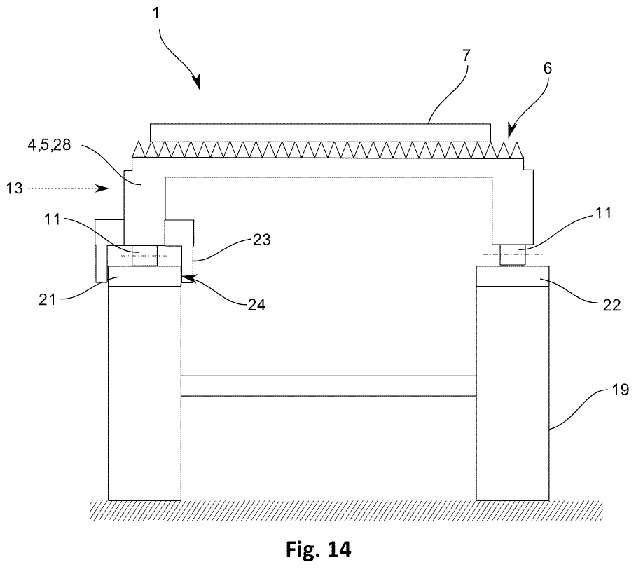

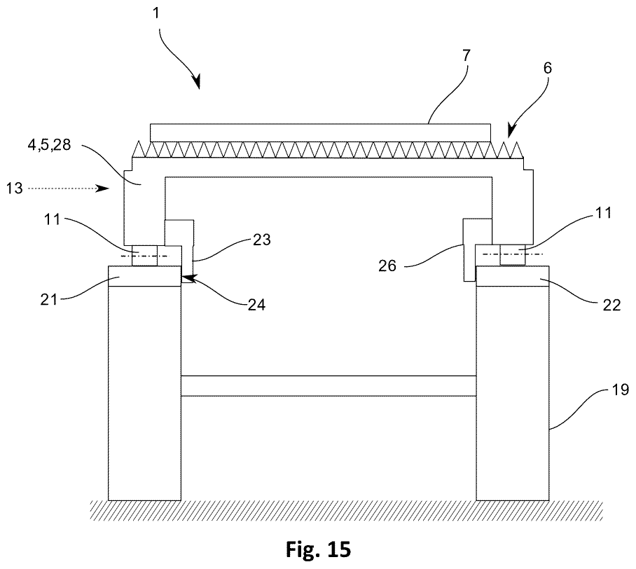

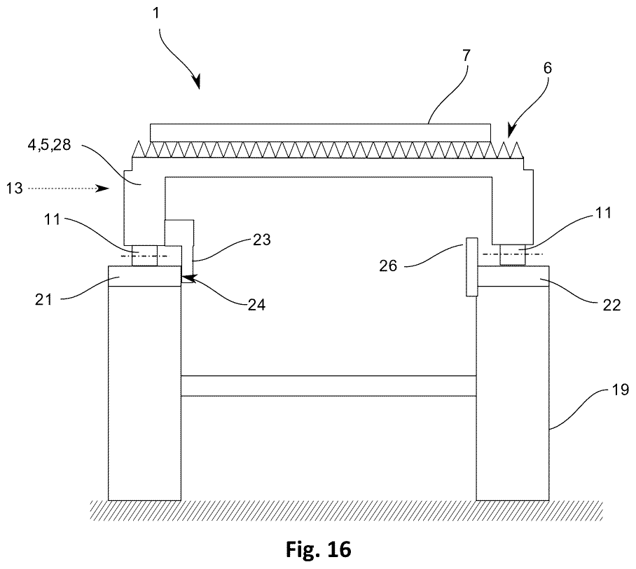

FIGS. 13-16 show embodiments in which one or more side guide elements 23, 26 are arranged on one, several or all pallets 4, 5, 28. FIG. 16 shows an embodiment in which a side guide element 23 is arranged on a pallet 4, 5, 28 and a side guide element 26 is arranged on the base frame 19.

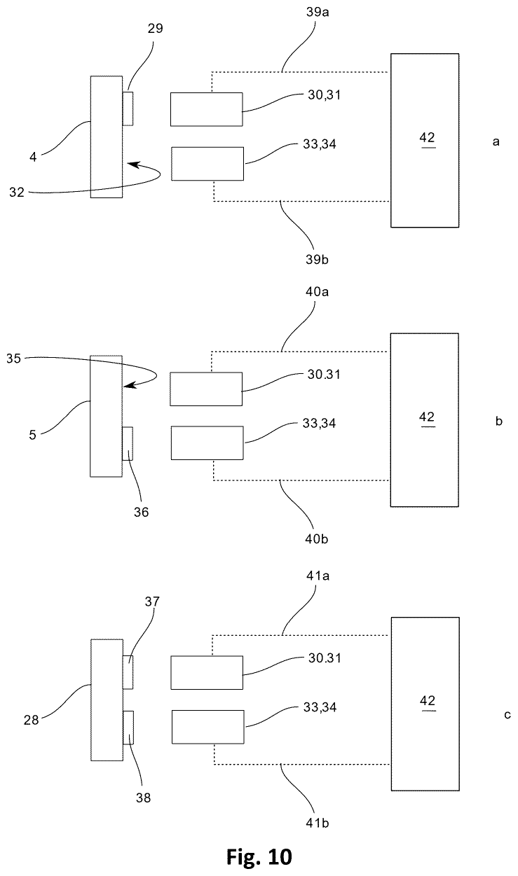

FIG. 10a shows a sensor system in which the first pallet 4 is equipped with a first sensor target 29. This sensor target 29 can be detected by a first sensor 30, which is firmly positioned opposite the first base frame 3, and by a second sensor 31, which is firmly positioned opposite the second base frame 19. In addition, the first pallet 4 has a second sensor target 32, which can be recognised by a third sensor 33, which is attached to the first base frame 3, and by a fourth sensor 34, which is arranged on the second base frame 19.

FIG. 10b shows another sensor system for the second pallet 5. This pallet carries a third sensor target 35, which is detected by the first sensor 30 on the first frame 3 and the second sensor 31 on the second frame 19. Furthermore, the second pallet 5 is equipped with a fourth sensor target 36, which can be recognised by the third sensor 33 on the first base frame 3 and the fourth sensor 34 on the second base frame 19.

FIG. 10c shows a sensor system for the third pallet 28. This pallet has a fifth sensor target 37, which is detected by the first sensor 30 on the first base frame 3 and the second sensor 31 on the second base frame 19. In addition, there is a sixth sensor target 38 on the third pallet 28, which can be detected by the third sensor 33 on the first base frame 3 and the fourth sensor 34 on the second base frame 19.

The sensor system is configured such that the first sensor target 29 and the second sensor target 32 of the first pallet 4, in combination with the sensors 30 and 33 of the first base frame 3 and the sensors 31 and 34 of the second base frame 19, are able to generate unambiguously sensor signals 39 that enable precise identification of the first pallet 4.

Similarly, the third sensor target 35 and the fourth sensor target 36 of the second pallet 5 are designed such that they generate unambiguous sensor signals 40 at the sensors 30 and 33 of the first base frame 3 and the sensors 31 and 34 of the second base frame 19, which ensure the identification of the second pallet 5.

Similarly, the fifth sensor target 37 and the sixth sensor target 38 of the third pallet 28 generate unambiguously sensor signals 41 which enable the third pallet 28 to be identified by being detected by the sensors 30, 33 of the first base frame 3 and the sensors 31, 34 of the second base frame 19.

All four sensors—the first sensor 30, the second sensor 31, the third sensor 33 and the fourth sensor 34—are designed as distance measurement sensors. These sensors precisely measure the distance to the respective sensor target, which enables accurate position detection of the pallets within the system.

The first sensor target 29 of the first pallet 4, the fourth sensor target 36 of the second pallet 5 and the fifth and sixth sensor targets 37, 38 of the third pallet 28 are each designed as elevations from the plane of the respective pallet. These elevations ensure precise and interference-free detection by the distance measurement sensors. In order to ensure that the three pallets 4, 5, 28 are unambiguously identified and at the same time to make the sensor system as simple as possible, the second sensor target 32 on the first pallet 4 and the third sensor target 35 on the second pallet 5 are designed as empty spaces and accordingly have no elevation or depression relative to the corresponding pallet surface that can be detected by the distance sensors.

In the embodiment shown, the first sensor target 29, the fourth sensor target 36 as well as the fifth sensor target 37 and the sixth sensor target 38 are designed as separate components. This design facilitates maintenance and replacement of the sensor targets.

This allows a pallet identification system to be realised, which is used to identify the pallets 4, 5, 28 and/or to confirm their position within the pallet changing system 1.

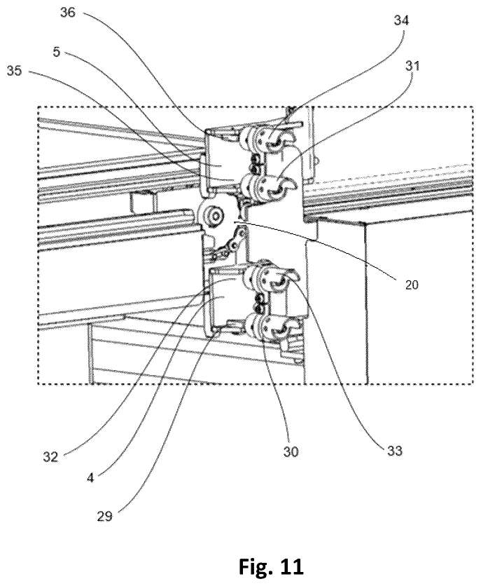

In the embodiment shown in FIG. 11, the pallet changing system 1 is equipped with a first base frame 3 and a second base frame 19, wherein the pallets 4,5,28, as already explained, can be moved between these base frames 3,19 and the laser processing machine 2. The pallets 4, 5, 28 are each provided with sensor targets 29, 32, 35, 37, which serve to identify the respective pallet 4, 5, 28. Each sensor target 29, 32, 35, 37 is arranged in such a way that it can be detected by a sensor 30, 31, 33, 34, which is mounted in a fixed position relative to the first base frame 3 or the second base frame 19. These sensors are used to detect the position of the pallets 4, 5, 28 within the pallet changing system 1. Each pallet 4, 5, 28 is equipped either with a sensor target 29, 35 on the upper sensor level, a sensor target 32, 36 on the lower sensor level or with two sensor targets 37, 38 on both levels. By reading out the sensor data, the control unit 42 of the pallet changing system can recognise the current position of the pallet 4, 5, 28 within the pallet changing system 1 and confirm, for example, that the corresponding pallet 4, 5, 28 has reached a predefined end position.

With the second base frame 19, only one group of proximity sensors 31,34 is required to detect the position of a pallet 4,5,28 in this station. This additional pallet station 19 makes it possible to integrate a third pallet 28 into the system and optimise the material flow by allowing all three pallets 4,5,28 to occupy different positions within the system.

The description of embodiments of the invention is not limited to the embodiments shown in the figures. The above description is therefore not to be regarded as limiting, but as explanatory. The following patent claims are to be understood as meaning that a named feature is present in at least one description of embodiments of the invention. This does not rule out the presence of further features. Insofar as the patent claims and the above description define ‘first’ and ‘second’ features, this Title serves to distinguish between two features of the same kind without establishing an order of precedence.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### PARTS LIST

1 Pallet changing system
2 Laser processing machine
3 Base frame
4 Pallet
5 Pallet
6 Contact surface
7 Workpiece
9 Running rail
10 Running rail
11 Rollers
13 Direction
14 Direction
19 Base frame
20 Drive system
21 Running rail
22 Running rail
23 Lateral guide element
24 Longitudinal extension side
25 Longitudinal extension side
26 Lateral guide element
27 Cross-section contour
28 Pallet
29 Sensor target
30 Sensor
31 Sensor
32 Sensor target
33 Sensor
34 Sensor
35 Sensor target
36 Sensor target
37 Sensor target
38 Sensor target
39 Sensor signals
40 Sensor signals
41 Sensor signals
42 Control unit
43 Guide contour

What is claimed is:

1. A material processing system, with a pallet changing system, the material processing system comprising
a first base frame,
a first pallet and a second pallet capable of being positioned on the first base frame in a movable and height-adjustable manner relative thereto, wherein each of the first pallet and the second pallet has a support surface for receiving a plate-shaped workpiece,
a first drive system, with which the first pallet and the second pallet are capable of being moved alternately from one another out of the first base frame into a material processing machine, which is positioned in alignment with a conveying direction of the pallet changing system, and back into the first base frame,
a second base frame arranged in alignment with the first base frame in the conveying direction of the pallet changing system, and
a second drive system connected to the second base frame, with which the first pallet and the second pallet are capable of being moved alternately from one another out of the second base frame into the first base frame and back into the second base frame,
wherein the second base frame has a first running rail and a second running rail running parallel to each other, on which the first pallet or the second pallet is capable of being displaced longitudinally in or out of a direction of the first base frame via rollers, and
wherein a guide contour is arranged on the first running rail and/or on the second running rail for laterally guiding at least one roller of the rollers, and/or wherein at least one lateral guide element is fixed relative to the second base frame or one of the first pallet and the second pallet arranged in the second base frame and projects beyond one of the first running rail and the second running rail at least in sections in such a way that, when a lateral force is applied with a force vector oriented perpendicular to a longitudinal extension of the first running rail or the second running rail from a first direction onto the first pallet or the second pallet arranged on the second base frame, lateral movement of the first pallet or the second pallet relative to the second base frame is limited by a one-sided stop against the at least one lateral guide element, thereby lateral displacement of the first pallet or the second pallet from the first running rail or the second running rail in the first direction is prevented.

2. The material processing system according to claim 1, wherein the at least one lateral guide element projects beyond one of the first running rail and the second running rail at least in the sections on a first longitudinal extension side and a second longitudinal extension side thereof in such a way that, when the lateral force is applied with the force vector oriented perpendicular to the longitudinal extension of the first running or the second running rail from the first direction or from a second direction on the first pallet or the second pallet, the lateral movement of the first pallet or the second pallet relative to the second base frame is limited by a stop on both sides against the lateral guide element, thereby the lateral displacement of the first pallet or the second pallet from the first running rail or the second running rail in the first direction and the second direction is prevented.

3. The material processing system according to claim 1 wherein the at least one lateral guide element projects beyond the first running rail at least in the sections on one of a first longitudinal extension side and a second longitudinal side thereof in such a way that, when the lateral force is applied to the first pallet or the second pallet from the first direction with the force vector oriented perpendicular to the longitudinal extension of the first running rail, the lateral movement of the first pallet or the second pallet relative to the second base frame is limited by the one-sided stop against the at least one lateral guide element, thereby the lateral displacement of the first pallet or the second pallet from the first running rail in the first direction is prevented, and wherein a further lateral guide element is fixed relative to the second base frame or the first pallet or the second pallet arranged in the second base frame and projects beyond the second running rail at least in sections on one of a first longitudinal extension side and a second longitudinal extension side thereof in such a way that, when the lateral force is applied with the force vector oriented perpendicular to the longitudinal extension of the second running rail from a second direction onto the first pallet or the second pallet, the lateral movement of the first pallet or the second pallet relative to the second base frame is limited by the one-sided stop against the further lateral guide element, thereby the lateral displacement of the first pallet or the second pallet from the second running rail in the second direction is prevented.

4. The material processing system according to claim 1, wherein the at least one lateral guide element is formed from a formed sheet metal.

5. The material processing system according to claim 1, wherein the at least one lateral guide element is fastened to the second base frame or to the first pallet or the second pallet arranged in the second base frame in a material-locking and/or force-locking and/or form-fitting manner.

6. The material processing system according to claim 1, wherein the at least one lateral guide element has a cross-sectional contour which reproduces a number six or is double-L-shaped.

7. The material processing system according to claim 1, further comprising a third pallet in the pallet changing system, wherein
the first pallet has a first sensor target capable of being detected by a first sensor arranged in a fixed position relative to the first base frame, and by a second sensor arranged in a fixed position relative to the second base frame, and
the first pallet has a second sensor target capable of being detected by a third sensor arranged in a fixed position relative to the first base frame, and by a fourth sensor arranged in a fixed position relative to the second base frame, and
the second pallet has a third sensor target capable of being detected by the first sensor arranged in the fixed position relative to the first base frame, and by the second sensor arranged in the fixed position relative to the second base frame, and
the second pallet has a fourth sensor target capable of being detected by the third sensor arranged in the fixed position relative to the first base frame, and by the fourth sensor arranged in the fixed position relative to the second base frame, and
the third pallet has a fifth sensor target capable of being detected by the first sensor arranged in the fixed position relative to the first base frame, and by the second sensor arranged in the fixed position relative to the second base frame, and
the third pallet has a sixth sensor target capable of being detected by the third sensor arranged in the fixed position relative to the first base frame, and by the fourth sensor arranged in the fixed position relative to the second base frame, wherein
the first sensor target and the second sensor target are configured such that sensor signals generated at the first sensor and the third sensor of the first base frame and at the second sensor and the fourth sensor of the second base frame enable unambiguous identification of the first pallet, and
the third sensor target and the fourth sensor target are configured such that sensor signals generated at the first sensor and the third sensor of the first base frame and at the second sensor and the fourth sensor of the second base frame enable unambiguous identification of the second pallet, and
the fifth sensor target and the sixth sensor target are configured in such a way that sensor signals generated at the first sensor and the third sensor of the first base frame and at the second sensor and the fourth sensor of the second base frame enable the third pallet to be unambiguously identified.

8. The material processing system according to claim 7, wherein the first sensor and/or the second sensor and/or the third sensor and/or the fourth sensor are/is designed as distance measuring sensors.

9. The material processing system according to claim 7, wherein the first sensor target and/or the second sensor target are/is formed as an elevation from a plane of the first pallet, and/or the third sensor target and/or the fourth sensor target are/is formed as an elevation from a plane of the second pallet, and/or the fifth sensor target and/or the sixth sensor target are/is formed as an elevation from a plane of the third pallet.

10. The material processing system according to claim 7, wherein the first sensor target, and/or the second sensor target, and/or the third sensor target, and/or the fourth sensor target, and/or the fifth sensor target, and/or the sixth sensor target are/is configured as a separate component.

11. The material processing system according to claim 1, further comprising a control unit connected to the first drive system and the second drive system and configured to control transportation of the first pallet or the second pallet from or to the first base frame or the second base frame, wherein the control unit is configured to actuate a simultaneous transport movement of the first pallet or the second pallet located on the first base frame by the first drive system and the first pallet or the second pallet located on the second base frame by the second drive system in a direction of the material processing machine.
